(19) United States
(12) Patent Application Publication
(10) Pub. No.: US 2010/0203776 A1
(43) Pub. Date: Aug. 12, 2010

(54) Socket Contact

(76) Inventor: Dezhong ZHAO, Shenyang (CN)

Correspondence Address: MATTHIAS SCHOLL, 14781 MEMORIAL DRIVE, SUITE 1319, HOUSTON, TX, 77079, US

(21) Appl. No.: 12/614,591

(22) Filed: Nov. 9, 2009

Related U.S. Application Data
(63) Continuation of application No. PCT/CN2008/000908, filed on May 8, 2008.

(30) Foreign Application Priority Data
May 9, 2007 (CN) 200710011222.3

(51) Int. Cl. H01R 4/48; H01R 13/33

(52) U.S. Cl. 439/840; 439/816

(57) ABSTRACT

A conductive contact base, comprising a conductive component, an elastic component, and a contact surface is described in which the conductive component is clamped by the elastic component, the conductive component opens and closes freely within an elastic limit whereby accommodating plugs with different sizes, and the contact surface is disposed between the conductive component and the elastic component. The conductive contact base of the invention has the advantages of a large contact surface, strong clamping force, good impact resistance, good vibration resistance, and good deformation resistance.

### CROSS-REFERENCE TO RELATED APPLICATIONS

This application is a continuation of International Patent Application No. PCT/CN2008/000908 with an international filing date of May 8, 2008, designating the United States, now pending, and further claims priority benefits to Chinese Patent Application No. 200710011222.3 filed on May 9, 2007. The contents of all of the aforementioned applications, including any intervening amendments thereto, are incorporated herein by reference.

### BACKGROUND OF THE INVENTION

1. Field of the Invention

The invention relates to an electricity technology area, and more particularly to a conductive contact base.

2. Description of the Related Art

Conventional conductive contact bases maintain their clamping force on plugs by deformation of the conductive contact bases themselves. However, there are several problems with the conductive contact bases:

(1) Contact between the conductive contact base and the plug is line contact that features small contact area, poor electrical contact performance, and small clamping force;

(2) Since the clamping force is imposed by deformation of the conductive contact base, only materials with required conductivity and deformation property are selected, which limits selection of the materials and implementation of performance.

### BRIEF SUMMARY OF THE INVENTION

In view of the above-described problems, it is one objective of the invention to provide a conductive contact base that addresses problems with the conventional conductive contact base and features a large contact surface and large clamping force.

In the invention, a socket, a contact base, and a concave contact refer to as a “female plug”, and a convex contact, a plug and a male contact refer to as a “male plug”.

The invention is implemented as follows:

A conductive contact base, comprising a conductive component, an elastic component, and a contact surface, wherein the conductive component is clamped by the elastic component, the conductive component opens and closes freely within an elastic limit whereby accommodating plugs with different sizes, and the contact surface is disposed between the conductive component and the elastic component.

The elastic component is a metallic elastic component with clamping force.

The elastic component is a triangular clamping spring made by an elastic metal sheet, the triangular clamping spring is in the shape of an isosceles triangle with a pair of symmetrical arcs at a clamping end thereof, a radius of each of the symmetrical arcs is 0.5-2 mm, and a thickness of the triangular clamping spring is 0.1-1 mm.

The elastic component is a triangular clamping spring, a helical wire spring, or a helical piece spring made of elastic metal wires.

The helical piece and the helical wire are wrapped on a circular shaft for 1-5 turns in one direction or in a reversed direction, a thickness of the helical piece is 0.1-0.5 mm, and a diameter of the helical wire is 0.2-2 mm.

The conductive components are conductive sheets, the conductive sheets are clamped by the triangular clamping spring, and shapes of the conductive sheets correspond to those of the clamping spring.

The conductive sheets are flat-shaped, circular, or square-shaped.

Bottom edges of the conductive sheets are connected together in the triangular clamping spring, and a connecting part therebetween is arc-shaped or triangular.

Multiple the female plug conductors are connected together via the conductive sheets, and the conductors are lengthened for fixing and connecting wires.

The conductive sheets extend to the outside of the clamping spring and are connected to each other.

A pair of grooves each having a flat-shaped opening are disposed on both sides of the female plug conductor whereby connecting two female plug conductors to the triangular clamping spring, and the female plug conductors are disposed side by side or in series.

A bayonet is disposed on the conductive sheet, the clamping spring comprises a clamping plate, a notch is disposed on the clamping plate, and the conductive sheets are fixed to the notch on the clamping plate via the bayonet.

The conductive sheets are fixed to the clamping plate of a concave support via riveting, welding, and compressing via a bolt.

The conductive component is a split cylindrical conductor clamped by a helical spring.

A split cylindrical female plug conductor is disposed on the other end of the female plug conductor, and 1-3 screw holes are disposed at the center of the female plug conductor.

The other end of the female plug conductor is a double-threaded-hole cylindrical conductor, and concave-convex processing is performed on the circumferential surface thereof whereby fixing the female plug conductor.

The other end of the female plug conductor is a mouth-shaped conductor welded with a rod, and concave-convex processing is performed on the circumferential surface of the rod whereby fixing the female plug conductor.

The other end of the female plug conductor is an axial inner-threaded conductor, and a diameter of a portion of the conductor with screw is 3-10 mm.

The other end of the female plug conductor is a long-bolt conductor.

The conductive contact base comprises a split cylindrical conductor and a hollow cylindrical conductor, the hollow cylindrical conductor is disposed at the center of the split cylindrical conductor, a gap is disposed between the hollow cylindrical conductor and the split cylindrical conductor, a helical piece clamping spring or a helical wire clamping spring is fit on the split cylindrical conductor, all parts of the split cylindrical conductor are not contacted with each other and in the shape of a flat, a male plug conductor is a split cylindrical conductor, and the male plug conductor is inserted in the gap between the hollow cylindrical conductor and the split cylindrical conductor.

Advantages of the invention comprise:

The conductive contact base of the invention features a large conductive contact surface, strong clamping force, and good impact resistance, vibration resistance and deformation resistance since the conductive sheet and the triangular clamping spring are used.

### BRIEF DESCRIPTION OF THE DRAWINGS

FIG. 1 is a schematic view of a conductive contact base in accordance with one embodiment of the invention.

FIG. 2 is a schematic view of a conductive contact base in accordance with another embodiment of the invention;

FIG. 3 is a schematic view of a conductive contact base in accordance with another embodiment of the invention;

FIG. 4 is a schematic view of a conductive contact base in accordance with another embodiment of the invention;

FIG. 5 is a schematic view of female plug conductors with lateral extending portions shown in FIGS. 1, 2, and 3;

FIG. 6 is a schematic view of a conductive contact base in accordance with another embodiment of the invention;

FIG. 7 is a schematic view of a conductive contact base in accordance with another embodiment of the invention;

FIG. 8 is a schematic view of a conductive contact base in accordance with another embodiment of the invention;

FIG. 9 is a schematic view of a conductive contact base in accordance with another embodiment of the invention;

FIG. 10 is a schematic view of a conductive contact base in accordance with another embodiment of the invention;

FIG. 11 is a schematic view of a conductive contact base in accordance with another embodiment of the invention;

FIG. 12 is a schematic view of a conductive contact base in accordance with another embodiment of the invention;

FIG. 13 is a schematic view of a conductive contact base in accordance with another embodiment of the invention;

FIG. 14 is a schematic view of a conductive contact base in accordance with another embodiment of the invention;

FIG. 15 is a schematic view of a conductive contact base in accordance with another embodiment of the invention;

FIG. 16 is a schematic view of a conductive contact base in accordance with another embodiment of the invention;

FIG. 17 is a schematic view of a conductive contact base in accordance with another embodiment of the invention;

FIG. 18 is a schematic view of a conductive contact base in accordance with another embodiment of the invention;

FIG. 19 is a schematic view of a conductive contact base in accordance with another embodiment of the invention;

FIG. 20 is a schematic view of a conductive contact base in accordance with another embodiment of the invention;

FIG. 21 is a schematic view of a conductive contact base in accordance with another embodiment of the invention;

FIG. 22 is a schematic view of a conductive contact base in accordance with another embodiment of the invention;

FIG. 23 is a schematic view of a conductive contact base in accordance with another embodiment of the invention;

FIG. 24 is a schematic view of a conductive contact base in accordance with another embodiment of the invention;

FIG. 25 is a schematic view of a conductive contact base in accordance with another embodiment of the invention;

FIG. 26 is a schematic view of a conductive contact base in accordance with another embodiment of the invention;

FIG. 27 is a schematic view of a conductive contact base in accordance with another embodiment of the invention;

FIG. 28 is a schematic view of a conductive contact base in accordance with another embodiment of the invention;

FIG. 29 is a schematic view of a conductive contact base in accordance with another embodiment of the invention;

FIG. 30 is a schematic view of a conductive contact base in accordance with another embodiment of the invention; and

FIG. 31 is a schematic view of a conductive contact base in accordance with another embodiment of the invention.

In which: 1, 2 conductive sheets; 3 triangular clamping spring; 4 extending portion; 5 clamping plate; 6 soft connecting wire; 7 concave bottom surface; 8 welding conductor; 9 welding conductor; 10 square spring; 21 bayonet; 22 split cylindrical conductor; 23 clamping spring; 24 conductor; 25 screw hole; 26 welding conductor; 27 inner-threaded conductor; 28 cold pressure conductor; 29 bolt conductor; 30 semicircular conductor; 31 double-folded metallic conductor; 32 flange seat conductor; 41, 42 conductors; 43 clamping spring; 44 male plug conductor.

### DETAILED DESCRIPTION OF THE INVENTION

Detailed description of the invention will be given below in conjunction with accompanying drawings.

### Example 1

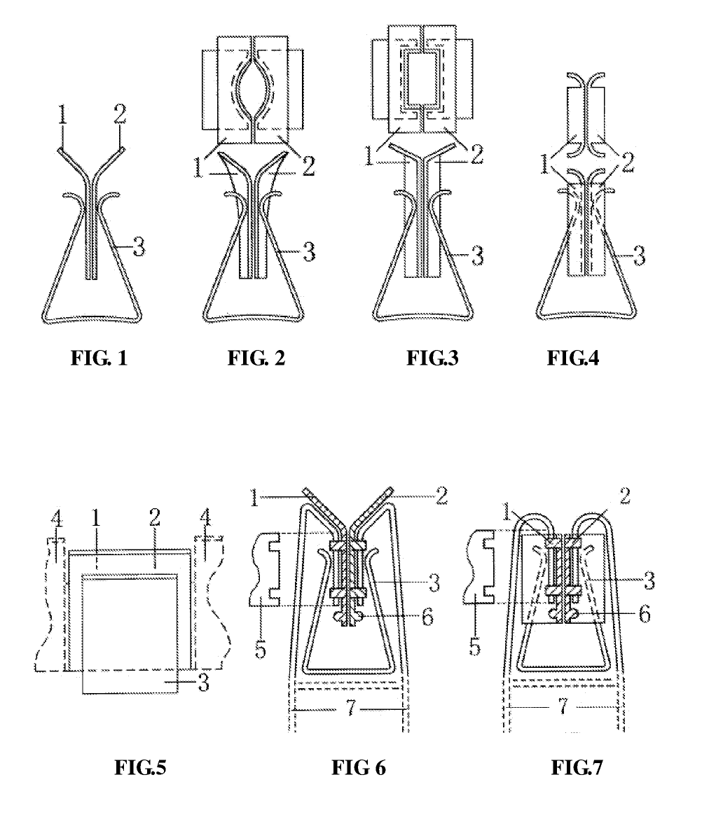

As shown in FIG. 1, a female plug conductor with a flat-shaped opening and comprising conductive sheets 1 and 2 is disposed in an opening of a triangular clamping spring 3. The conductive sheets 1 and 2 can be connected altogether.

The triangular clamping spring 3 is a symmetrical triangular elastic component with an opening that is formed by an elastic metal sheet. Two symmetric angles are fillets and a bottom edge thereof is comparatively narrow. For easy clamping of the opening, the opening is arc-shaped. Since the triangular clamping spring is imposed by forces generated by deformation of the three metal sheets, clamping force thereof is large and the size thereof is small. To improve deformation resistance of a clamping opening thereof, a thickness of the sheet is preferably 0.15-4 mm. Normally a height thereof is 9-12 mm, and a width of a bottom edge of the triangle is preferably 6-8 mm. Two symmetric angles of the triangle are fillets with a radius preferably 0.5-0.7 mm, a width of 6-9 mm, and a thickness of 0.2 mm. As required, other sizes can be used, a width thereof can be 2-3 mm, and a thickness thereof can be increased. The triangular clamping spring 3 operates to receive metallic conductors.

The triangular clamping spring 3 can be made by elastic metal wires. To ensure correct clamping, an opening thereof is arc-shaped or flat-shaped, and is formed by two curved wires. The triangular clamping spring made by metal wires is almost the same as that made by metal sheets.

The above-mentioned metallic elastic components are made by high-quality elastic materials that are processed and strengthened by heat and feature good reliability of contact conduction.

The above-mentioned female plug conductor cannot be fixed independently, and must be attached to a lateral extending conductor or disposed in a concave elastic clamping plate.

### Example 2

As shown in FIG. 2, another embodiment of the invention comprises a metallic conductive sheet formed by two conductive sheets 1 and 2 each with a semicircular notch, and a triangular clamping spring 3 operating to receive the metallic conductive sheet. The conductive contact base is applicable to a circular plug.

### Example 3

As shown in FIG. 3, another embodiment of the invention comprise a clamping sheet with a square opening and comprising conductive sheets 1 and 2 each with a semi-square opening.

And a triangular clamping spring operates to receive the clamping sheet. The conductive contact base is applicable to a square plug.

### Example 4

As shown in FIG. 4, another embodiment of the invention comprise a female plug conductor having a pair of curved conductive sheets 1 and 2 on both sides thereof, and a triangular clamping spring operating to receive the female plug conductor.

### Example 5

As shown in FIG. 5, the female plug conductors in FIGS. 1, 2 and 3 are each attached to a lateral extending conductor. A conductive sheet 1 and the lateral extending conductor 4, and a conductive sheet 2 and the lateral extending conductor 4 are connected altogether and fixed in an insulating gap.

### Example 6

As shown in FIG. 6, the female plug conductor comprises a concave elastic metal support and a triangular clamping spring. An opening is disposed on each of the conductive sheets 1 and 2. The conductive sheets 1 and 2 are welded with a soft connecting wire 6 and disposed in an opening of the concave elastic metal support, and a triangular clamping spring 3 is disposed outside the opening. A concave bottom surface 7 of the concave elastic metal support can use different shapes. The conductive sheets 1 and 2 are received in the clamping plate 5 with a notch of the concave elastic metal support via their own openings.

### Example 7

As shown in FIG. 7, the female plug conductor comprises a concave contact base and a triangular clamping spring. An opening is disposed on each of the conductive sheets 1 and 2. The conductive sheets 1 and 2 are welded with a soft connecting wire 6 and disposed in an opening of the concave elastic metal support, and a triangular clamping spring 3 is disposed outside the opening. A concave bottom surface 7 of the concave elastic metal support can use different shapes. The conductive sheets 1 and 2 are received in the clamping plate 5 with a notch of the concave elastic metal support via their own openings.

### Example 8

As shown in FIG. 8, another embodiment of the invention is illustrated. The bottom of conductive sheets 1 and 2 are connected altogether, a connecting part therebetween is oblate, and a welding conductor 8 is led out from one side thereof. The conductive sheets 1 and 2 are received in the triangular clamping spring 3 to form a female plug conductor. An edge at the bottom of the conductive sheet is made into a connecting body disposed in the triangular clamping spring. Due to requirements for a freedom degree, the connecting body is arc-shaped or triangular, and is an independent body fixed in an insulating housing. A connecting conductor is extended from the one side or both sides of the connecting body. After the triangular clamping spring is added, the female plug conductor with metal sheets is formed.

### Example 9

As shown in FIG. 9, another embodiment of the invention is illustrated. The bottom of conductive sheets 1 and 2 are connected altogether, a connecting part therebetween is oblate, and a welding conductor 8 is led out from one side thereof. The conductive sheets 1 and 2 are received in the triangular clamping spring 3 to form a female plug conductor.

### Example 10

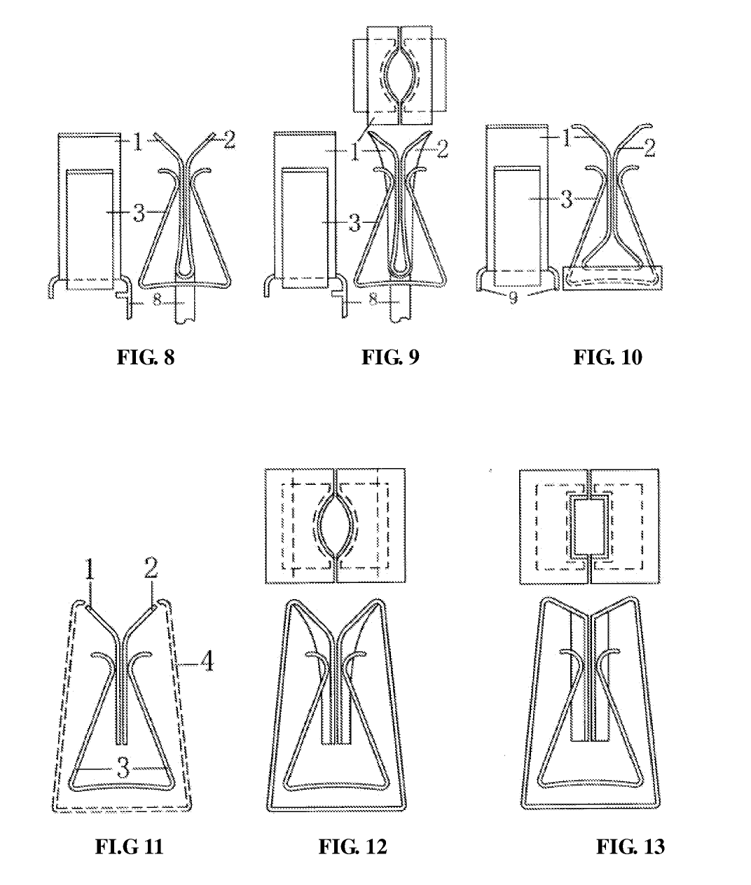

As shown in FIG. 10, another embodiment of the invention is illustrated. The bottom of conductive sheets 1 and 2 are connected altogether, a connecting part therebetween is triangular, and welding conductors 9 are led out from both sides thereof. The conductive sheets 1 and 2 are received in the triangular clamping spring 3 to form a female plug conductor.

### Example 11

As shown in FIG. 11, another embodiment of the invention is illustrated. The bottom of conductive sheets 1 and 2 extend downwards from the upper edge and wrap around the triangular clamping spring 3 for one circle whereby forming a curved extending conductor 4. The conductive sheets 1 and 2 are received in the triangular clamping spring 3 to form a female plug conductor.

### Example 12

As shown in FIG. 12, another embodiment of the invention is illustrated. Two semi-circular conductive sheets 1 and 2 each with an opening are received in the triangular clamping spring 3 to form a female plug conductor like example 11. The conductive contact base is applicable for circular plugs.

### Example 13

As shown in FIG. 13, another embodiment of the invention is illustrated. Two semi-square conductive sheets 1 and 2 each with an opening form a clamping sheet. The conductive sheets 1 and 2 extend downwards from the upper edge and wrap around the triangular clamping spring 3 for one circle whereby forming an extending conductor 4. The conductive sheets 1 and 2 are received in the triangular clamping spring 3 to form a female plug conductor. The conductive contact base is applicable for square plugs.

### Example 14

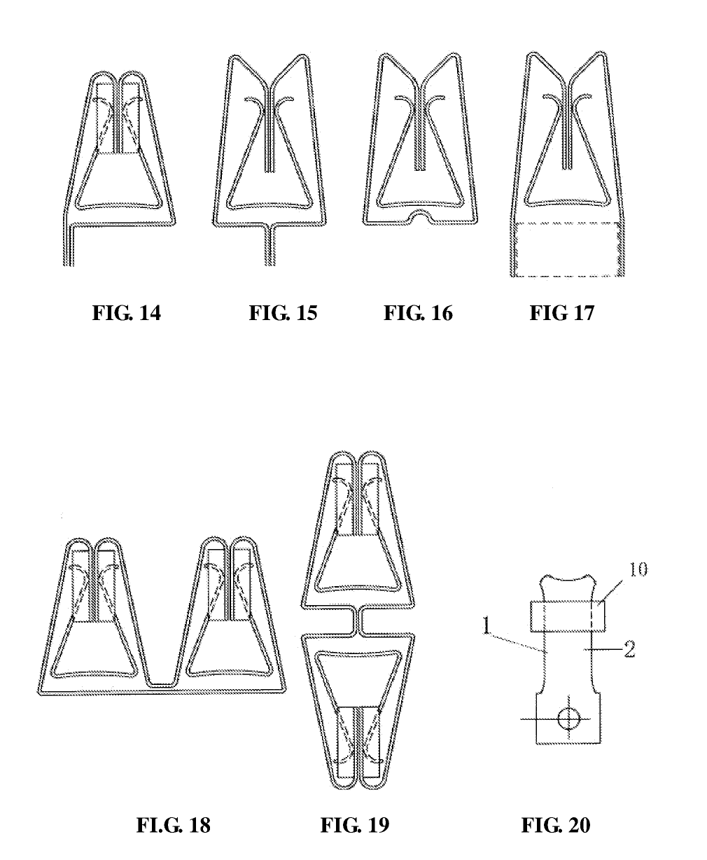

As shown in FIG. 14, another embodiment of the invention is illustrated. Two conductive sheets 1 and 2 form a clamping sheet with openings on both sides. The conductive sheets 1 and 2 extend downwards from the upper edge and wrap around the triangular clamping spring 3 for one circle. One side of the bottom of the triangular clamping spring is curved for fixing and connecting wires. The conductive sheets 1 and 2 are received in the triangular clamping spring 3 to form a female plug conductor.

### Example 15

As shown in FIG. 15, another embodiment of the invention is illustrated. The conductive sheets 1 and 2 extend downwards from the upper edge and wrap around the triangular clamping spring 3 for one circle. The center of the bottom of the triangular clamping spring is curved for fixing and connecting wires. The conductive sheets 1 and 2 are received in the triangular clamping spring 3 to form a female plug conductor.

### Example 16

As shown in FIG. 16, another embodiment of the invention is illustrated. The conductive sheets 1 and 2 extend downwards from the upper edge and wrap around the triangular clamping spring 3 for one circle whereby forming an extending conductor. A groove is disposed at the bottom of the triangular clamping spring for fixing and connecting wires. The conductive sheets 1 and 2 are received in the triangular clamping spring 3 to form a female plug conductor.

### Example 17

As shown in FIG. 17, another embodiment of the invention is illustrated. The conductive sheets 1 and 2 extend downwards from the upper edge and wrap around the triangular clamping spring 3 whereby forming an extending conductor for fixing and connecting wires. The conductive sheets 1 and 2 are received in the triangular clamping spring 3 to form a female plug conductor.

### Example 18

As shown in FIG. 18, conductive sheets of the female plug connector in FIG. 14 are connected at the bottom of two opposite sides whereby forming a conductive contact base.

### Example 19

As shown in FIG. 19, conductive sheets of the female plug connector in FIG. 14 are connected at the bottom thereof whereby forming a conductive contact base.

### Example 20

As shown in FIG. 20, another embodiment of the invention is illustrated. The circular contact base with a clamping spring comprises two cylindrical conductive sheets 1 and 2, and a square spring 10. The root of the conductive sheet 1 and that of the conductive sheet 2 are in the shape of a flat and not connected to each other. The cylindrical structure has a freedom degree, which makes the spring tightly clamp the contact base.

### Example 21

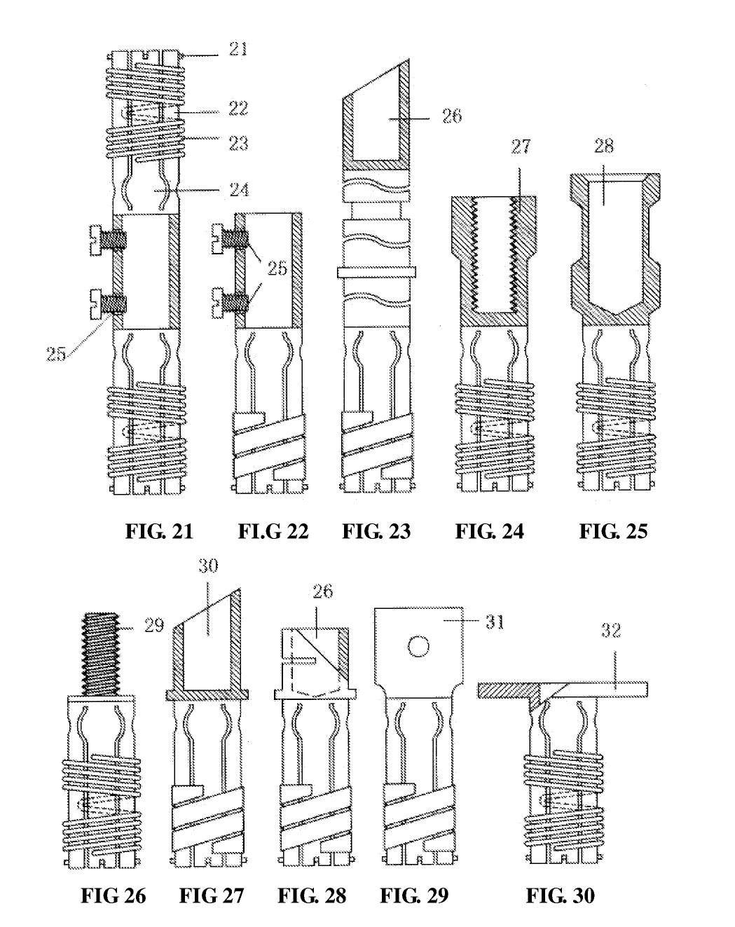

As shown in FIG. 21, a conductive contact base with a female plug conductor having a pair of clamping springs on both ends thereof is illustrated. 1-3 screw holes are disposed at the center thereof, and bolts are inserted therein for fixing conductors in the socket.

A conductive contact base with a clamping spring is disposed on the other end thereof. 1-3 screw holes 25 are disposed at the center thereof, and bolts are inserted in the female plug conductor for fixing.

The clamping spring 43 may be a helical piece spring. An elastic metal sheet is wrapped on a circular shaft for 1-3 turns. Both ends of the elastic metal sheet are made flat, and are cylindrical in an axial direction. The elastic metal sheet is fit on the circumference of the split cylindrical socket. The clamping spring can have different dimensions according to a diameter, a thickness and a width of the spring sheet.

The clamping spring 43 can be a helical wire spring. Helical wires are wrapped on a circular shaft for 2-5 turns in one direction or in a reversed direction. The clamping spring can have different dimensions according to a diameter, a thickness and the number of turns of the spring wire. 2-5 turns of spring wires are fit on the circumference of the split cylindrical socket in one direction or in a reversed direction.

The above-mentioned metallic elastic components are made by high-quality elastic materials that are processed and strengthened by heat and feature good reliability of mechanical contact conduction.

The above-mentioned female plug conductor cannot be fixed independently, and must be attached to a lateral extending conductor or disposed in a concave elastic clamping plate.

### Example 22

As shown in FIG. 22, one end of the female plug conductor is a conductive contact base with a clamping spring, and the other end thereof is a cylindrical conductor. Two screw holes are disposed on the cylindrical conductor. The other end is cylindrical, namely two screw holes are disposed on the cylindrical conductor. Inserted wires are fixed by screws, and insulating covers are disposed on both ends thereof. A current socket for an industrial connector uses two bolts.

### Example 23

As shown in FIG. 23, one end of the female plug conductor is a conductive contact base with a clamping spring, and the other end thereof is a conductor welded with a rod. A cog or a groove is disposed on the welding conductor 26 for injection and fixing, and a hole is disposed on one head of the rod for welding wires. A cog or a groove is disposed on the circumference of the conductor for fixing the female plug conductor, and multiple grooves are disposed for injection and fixing. A welding conductor 26 is disposed on one head of the rod for welding wires. This method is applicable for space female plug conductors.

### Example 24

As shown in FIG. 24, a conductive contact base is disposed at one end of the female plug conductor and an axial inner-threaded conductor 27 is disposed at the other end of a female plug conductor. The outermost portion of the circumference of the axial screw is thicker than other portions thereof whereby making it possible to fix the female plug conductor. The other end is the cylindrical conductor, namely a screw connected to the inner nut. The outermost portion of the circumference of the axial screw is 5-10 mm thicker than other portions thereof whereby making it possible to fix the female plug conductor. The female plug conductor in this example is applicable to connection of a soft wire conductor.

### Example 25

As shown in FIG. 25, a conductive contact base is disposed at one end of a female plug conductor and a cold pressure conductor 28 is disposed at the other end of the female plug conductor.

A cylindrical conductor 28 having a concave center is disposed on the other end thereof. The groove operates to compress and connect wires via cold pressure, and both sides thereof are comparatively high for fixing the female plug conductor. The female plug conductor in this example is applicable to the connection conductor of a heavy-duty connector.

### Example 26

As shown in FIG. 26, a conductive contact base is disposed at one end of the female plug conductor and a bolt conductor 29 is disposed at the other end of a female plug conductor. The bolts of the bolt conductor 29 are either hollow or solid. A hollow bolt is used for welding. The bolt has many applications such as fixing the female plug conductor and disposing a wire on the bolt via a nut. Multiple sockets can be fixed on a conducting plate whereby forming a separating terminal. The bolts are also applicable to some connectors.

### Example 27

As shown in FIG. 27, a conductive contact base is disposed at one end of a female plug conductor and the welding conductor 26 is disposed at the other end of the female plug conductor. A cylindrical conductor interface with the welding conductor 26 is processed to form an oblique opening having an angle of 60°. A cog or a groove is disposed at the welding conductor 26 to fix the female plug conductor. A wire is inserted into the oblique opening and is welded to the oblique opening.

### Example 28

As shown in FIG. 28, a conductive contact base with a clamping spring is disposed on one end of a female plug conductor and a conductor with a semicircular opening is disposed at the other end of the female plug conductor. A cog is disposed outside the circumference for fixing the conductor of the female plug conductor. A small semicircular gap is positioned at a distance of 6-8 mm from the connecting terminal of the triangular clamping spring 30. The small semicircle is compressed toward the center of the conductor to fix the inserted wire. The compressed small semicircle forms a concave semicircular structure. A cog or a groove is disposed at the welding conductor to fix the female plug conductor and a socket bolt is inserted into the screw hole to fix the conductor that had been inserted into the socket. The female plug conductor of this example is applicable to space flight applications.

### Example 29

As shown in FIG. 29, a conductive contact base is disposed on one end of the female plug conductor and a double-folded metallic conductor with a screw hole is disposed on the other end of the female plug conductor. The double-folded metallic conductor 31 with a screw hole is disposed on the other end thereof.

### Example 30

As shown in FIG. 30, a conductive contact base with a clamping spring is disposed on one end of a female plug conductor and a flange-shaped seat conductor is disposed on the other end thereof. The conductive contact base with the clamping spring is directly and vertically disposed on a ring-shaped conductive sheet. A hollow core or solid core cylindrical conductor is freely to rotate in the socket. A reliable conductive contact can be achieved, which makes the invention widely applicable to conductive contact of rotary switches.

### Example 31

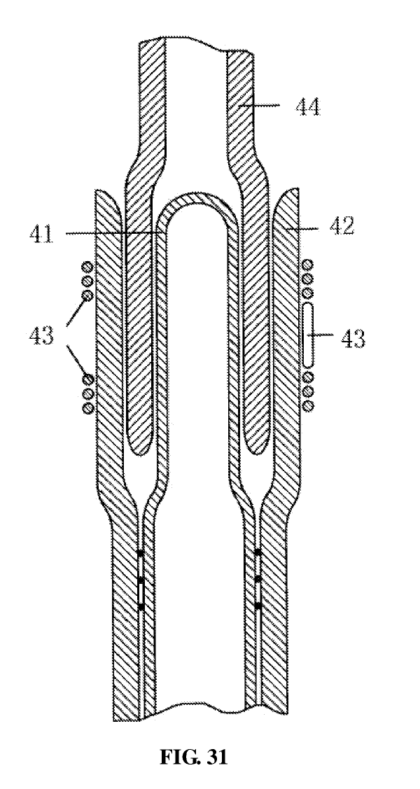

As shown in FIG. 31, conductors 41 and 42 are female plugs, and a conductor 44 is a male plug. The conductive contact base with a clamping spring is a split cylindrical female plug conductor and a split cylindrical male plug conductor.

The split cylindrical female plug conductor comprises a split cylindrical female plug conductor 42 and a hollow cylindrical conductor 41. The hollow cylindrical conductor 41 is disposed at the center of the split cylindrical female plug conductor. The split cylindrical female plug conductor and the hollow cylindrical conductor are concentric, and a gap is disposed therebetween. The helical piece or wire clamping spring is tightly fit thereon whereby forming an electric component of the convex-concave female plug conductor. A male plug conductor is tightly inserted into the gap. The male plug conductor comprises the split cylindrical female plug conductor. During production of the split cylindrical female plug conductor, the conductor connected to the male plug and the convex-concave female plug can be a conductor in any shape of the above-mentioned ten examples.

Each part of the split cylindrical conductor is in the shape of a flat and not connected to each other. To ensure the male plug conductor is tightly inserted in the gap, the male plug conductor is composed of the split cylindrical female plug conductor, and is referred to as a male plug. The convex-concave female plug comprises the male plug and the female plug, and is referred to as a female-male plug conductor.

The mechanical processing requirements for the conductive contact bases with clamping springs as described in Examples 21-31 are as follows.

1) determination of tolerance and fit: mechanical processing of an inner diameter of the cylindrical conductor uses a “basic shaft” system, and the inner diameter, the circumference of the cylindrical conductor both have a fineness. A tolerance between the inner diameter of the cylindrical conductor and the cylindrical plug is φ-0.01.

2) Mechanical processing requirements of the cylindrical socket plughole: an inner edge of each end of the cylindrical conductor is processed to form a bell-shaped mouth whereby facilitating insertion of a cylindrical plug. A rib having a height of 0.1-0.8 mm or a bayonet 21 is processed along the outer edge of the cylindrical conductor to prevent the clamping spring 23 from slipping out.

3) The cylindrical conductor is processed into 4-8 pieces. The gap between pieces varies from 0.1 to 1.2 mm. The length of each piece varies from 13 to 20 mm as needed. A burr produced during processing must be removed.

4) Processing of a root 24 of the split cylindrical conductor 22. The root 24 refers to an end of a separated part of the split cylindrical conductor 22. The processing comprises turning an arc into a line and then to an arc. The length thereof is 3-5 mm. The purpose of the process is to increase the freedom degree between the parts.

5) reshaping process after processing, compression and handling of freedom degree are performed inside and outside the plughole.

6) combination of female plug conductor and the clamping spring, the helical piece spring or helical wire spring that forms the female plug conductor is tightly fit on the cylindrical conductor to form a conductive contact base with the clamping spring.

As shown in Examples 1-20, conductive components adapted to flat-shaped conductors, flat-shaped plugs or contacts are metal conductive sheets each having an opening in an inserting direction. The opening is divided into a single-side opening and a double-side opening. The single-side opening is for direct inserting, and the double-side opening is for rotary inserting.

As shown in Examples 21-31, conductive components adapted to cylindrical conductors, circular plugs or cylindrical contacts are split cylindrical conductors. The root thereof is the end of the separated piece, and should be made from an arc shape into a flat shape, whereby improving freedom degree of the split conductor.

The conductive component corresponding to the square plug is a four-piece square conductor and complies with the UK standard. Only two surfaces of the two-piece square conductor contact with the conductor. The two-piece square conductor can be made into a pair of metal conductive sheets in a low-current condition.

The commonly used contact conductor comprises two types, a conductor with a flat-shaped plug, and a conductor with a cylindrical plug. The corresponding female plug conductors comprise a metal piece conductor having two surfaces for mechanical contact and a split cylindrical metal conductor for sliding contact. At present, there are many ways to fix the contact conductor and to connect wires, and several female plug conductors are disposed on one conductor. Various design options for the female plug conductor are as follows:

1) As shown in Examples 1-20, the flat-shaped female plug conductor and the cylindrical female plug conductor can be molded into different shapes in a horizontal or vertical direction on the inner/outer conductor of the triangular clamping spring, whereby adapting to different shapes of fixed conductors, wiring conductors, freedom conductors, connecting conductors, and multiple female plug conductors, namely connecting conductors of female plugs.

2) As shown in Examples 21-31, a half part of the female plug conductor along an axial direction, namely the conductor of the female plug conductor that contacts with the male contact can be designed to have different shapes as needed, for meeting requirements for various fixing and wiring methods of the female plug conductors.

3) As shown in Example 31, multiple contact surfaces are disposed at the circumferential surface of the split cylindrical female plug conductor to form multiple layers of conductors. The split cylindrical female plug conductor and the cylinder male plug conductor form concentric convex-concave female plug conductor.

As shown in Examples 1-20, the female plug conductor, namely the conductive contact base with the clamping spring comprises:

1) Composition of the double-folded metallic female plug conductor with a clamping spring: Female plug conductive sheets containing a flat-shaped opening on one side, a circular opening on one side, a square opening on one side, and two flat-shaped openings on both sides are clamped by the triangular clamping springs to form the basic female plug conductor contacted with the male plug conductors. However, these components cannot be fixed, and can only be fixed in an insulating housing by laterally or vertically extending the conductor, or fixed in the clamping plate of the concave elastic support. Wires can be disposed at the back of the female plug metal sheet.

2) An edge at the bottom of the conductive sheet is made into a connecting body disposed in the triangular clamping spring. Due to requirements for a freedom degree, the connecting body is arc-shaped or triangular, and is an independent body fixed in an insulating housing. A connecting conductor is extended from the one side or both sides of the connecting body. After the triangular clamping spring is added, the female plug conductor with conductive sheets is formed.

3) the clamping plate in the concave conductor forms the concave female plug conductor: the metallic clamping sheets with a flat-shaped opening on one side, a circular opening on one side, and two flat-shaped openings on both sides are vertically bent, lengthened and extended to wrap around the triangular clamping spring for one circle, and thus contact conductors with a concave flat-shaped openings, concave circular openings, and two flat-shaped openings are formed. The concave female plug conductor is made by a clamping-plate-type conductor, a curved conductor, a connecting conductor, and a wiring conductor.

(1) The bottom surface of the concave female plug conductor can be made into different shapes for fixing and wiring, for example, one with a long tail on one side, one with a long tail at the center, one with a concave circular opening, one with no bottom and two long tails on both sides.

(2) Multiple concave triangular female plug conductors each with two flat-shaped openings on both sides thereof are connected together in series or side by side. The two concave triangular female plug conductors tightly clamp the contact conductors. All concave triangular female plug conductors can be used as concave elastic metal supports, which forms a switching female plug conductor with female plug conductors formed by metal conductive sheets.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A conductive contact base, comprising:
a conductive component,
an elastic component; and
a contact surface,
wherein,
said conductive component is clamped by said elastic component;
said conductive component opens and closes freely within an elastic limit whereby accommodating plugs with different sizes; and
said contact surface is disposed between said conductive component and said elastic component.

2. The conductive contact base of claim 1, wherein said elastic component is a metallic elastic component with clamping force.

3. The conductive contact base of claim 1, wherein
said elastic component is a triangular clamping spring (3) made by an elastic metal sheet,
said triangular clamping spring is in the shape of an isosceles triangle with a pair of symmetrical arcs at a clamping end thereof,
a radius of each of said symmetrical arcs is 0.5-2 mm, and
a thickness of said triangular clamping spring is 0.1-1 mm.

4. The conductive contact base of claim 1, wherein said elastic component is a triangular clamping spring, a helical wire spring, or a helical piece spring made of elastic metal wires.

5. The conductive contact base of claim 1, wherein
said helical piece and said helical wire are wrapped on a circular shaft for 1-5 turns in one direction or in a reversed direction;
a thickness of said helical piece is 0.1-0.5 mm, and
a diameter of said helical wire is 0.2-2 mm.

6. The conductive contact base of claim 1, wherein
said conductive components are conductive sheets (1, 2);
said conductive sheets (1, 2) are clamped by said triangular clamping spring (3); and
shapes of said conductive sheets (1, 2) correspond to those of said clamping spring.

7. The conductive contact base of claim 6, wherein said conductive sheets (1, 2) are flat-shaped, circular, or square-shaped.

8. The conductive contact base of claim 6, wherein
bottom edges of said conductive sheets (1, 2) are connected together in said triangular clamping spring (3); and
a connecting part therebetween is arc-shaped or triangular.

9. The conductive contact base of claim 6, wherein
multiple said female plug conductors are connected together via said conductive sheets (1, 2); and
said conductors are lengthened for fixing and connecting wires.

10. The conductive contact base of claim 6, wherein said conductive sheets (1, 2) extend to the outside of said clamping spring (3) and are connected to each other.

11. The conductive contact base of claim 9, wherein
a pair of grooves each having a flat-shaped opening are disposed on both sides of said female plug conductor whereby connecting two female plug conductors to said triangular clamping spring; and
said female plug conductors are disposed side by side or in series.

12. The conductive contact base of claim 6, wherein
a bayonet is disposed on said conductive sheet;
said clamping spring comprises a clamping plate;
a notch is disposed on said clamping plate (5), and
said conductive sheets are fixed to said notch on said clamping plate via said bayonet.

13. The conductive contact base of claim 6, wherein said conductive sheets are fixed to said clamping plate of a concave support via riveting, welding, and compressing via a bolt.

14. The conductive contact base of claim 1, wherein said conductive component is a split cylindrical conductor clamped by a helical spring.

15. The conductive contact base of claim 9, wherein
a split cylindrical female plug conductor is disposed on the other end of said female plug conductor; and
1-3 screw holes are disposed at the center of said female plug conductor.

16. The conductive contact base of claim 9, wherein
the other end of said female plug conductor is a double-threaded-hole cylindrical conductor; and
concave-convex processing is performed on the circumferential surface thereof whereby fixing said female plug conductor.

17. The conductive contact base of claim 9, wherein
the other end of said female plug conductor is a mouth-shaped conductor welded with a rod; and
concave-convex processing is performed on the circumferential surface of said rod whereby fixing said female plug conductor.

18. The conductive contact base of claim 9, wherein,
the other end of said female plug conductor is an axial inner-threaded conductor; and
a diameter of a portion of said conductor with screw is 3-10 mm.

19. The conductive contact base of claim 9, wherein the other end of said female plug conductor is a long-bolt conductor.

20. The conductive contact base of claim 1, wherein,
said conductive contact base comprises a split cylindrical conductor (42) and a hollow cylindrical conductor (41);
said hollow cylindrical conductor (41) is disposed at the center of said split cylindrical conductor (42);
a gap is disposed between said hollow cylindrical conductor and said split cylindrical conductor;
a helical piece clamping spring or a helical wire clamping spring is fit on said split cylindrical conductor;
all parts of said split cylindrical conductor are not contacted with each other and in the shape of a flat;
a male plug conductor is a split cylindrical conductor (44); and
said male plug conductor is inserted in said gap between said split cylindrical conductor and said cylindrical conductor.
